(19) United States
(12) Patent Application Publication
(10) Pub. No.: US 2010/0078360 A1
(43) Pub. Date: Apr. 1, 2010

(54) Waste recycling apparatus and process thereof

(76) Inventor: Joseph Trocino, Poughkeepsie, NY (US)

Correspondence Address: AHSAN & ASSOCIATES, P.O. BOX 251, HOPEWELL JUNCTION, NY, 12533, US

(21) Appl. No.: 12/286,428

(22) Filed: Sep. 30, 2008

(51) Int. Cl. B03B 9/06

(52) U.S. Cl. 209/2

(57) ABSTRACT

The present invention relates generally to waste recycling. More particularly, the invention encompasses a waste recycling apparatus. The invention further includes a process for processing and sorting waste, such as, at a landfill location. The incoming waste is processed so that the incoming waste can be sorted into valuable waste and worthless waste. The valuable waste is removed and further recycled, while the worthless waste is moved into a landfill or similar such location.

### FIELD OF THE INVENTION

The present invention relates generally to waste recycling. More particularly, the invention encompasses a waste recycling apparatus. The invention further includes a process for processing and sorting waste, such as, at a landfill location. The incoming waste is processed so that the incoming waste can be sorted into valuable waste and worthless waste. The valuable waste is removed and further recycled, while the worthless waste is moved into a landfill or similar such location.

### BACKGROUND INFORMATION

Disposal of waste, such as, household waste, construction and demolition debris, etc. has become a major problem in developed countries. In some situations the waste from municipalities is either being sent to a different state or maybe to a different country.

Landfill laws are also becoming more stringent and this further increases the cost of waste disposal. Landfill locations are also decreasing in numbers and thus the landfill owners are looking for options for the waste that is being brought to the landfill.

There is also a growing movement to reduce waste and to recycle waste as much as possible. For example, most municipalities now require sorting of recyclable paper, recyclable glass, recyclable metals from ordinary household garbage for separate processing.

Some of the towns and communities also provide one or more days where residents can bring their bulk material to a location and have that bulk item disposed for free or for a small fee. These bulk items or material typically include, refrigerators, air conditioners, hot water heaters, dish washers, stoves, small kitchen appliances, mattress and box springs, yard materials, to name a few.

U.S. Pat. No. 4,080,760 (Raymond M. Leliaert), the disclosure of which is incorporated herein by reference, discloses a magnetic separator which is incorporated in a surface treatment device, such as, a particulate throwing wheel employing a rebound system to recycle the particulate. The separator includes a porous rotating drum having a set of magnets therebeneath to attract ferromagnetic particulate. A portion of the drum is pressurized so that nonmagnetic debris intermingled with the particulate is blown free and conveyed to a dust collector.

U.S. Pat. No. 4,585,548 (Mark D. Cadzow, et al.), the disclosure of which is incorporated herein by reference, discloses recovery of metal values from mineral ores by incorporation in coal-oil agglomerates where a gold ore, or any other mineral treated to have a lyophilic surface, (e.g. chalcopyrites), is ground into a slurry in crusher (1) powdered coal and oil are added at location (2), and the mix is conveyed to a contact zone (3), where any micro-agglomerates formed are kept below 500 microns in size. Sequentially, the mix is passed to an agglomeration zone (4), where larger agglomerates of coal-oil and gold or the lyophilic mineral are allowed to form, then separated at (5) from the gangue (8), and recycle continuously via return line (6) and homogenister (7) to the contact zone (3), until a desired gold or mineral concentration in the agglomerates is achieved. Subsequently, the ‘loaded’ coal-oil agglomerates are tapped off the return line (6) at (9), either batchwise or continuously, and the metal values are recovered by pyrometallurgical or concentional separation techniques.

U.S. Pat. No. 5,655,719 (Roland A. Getz), the disclosure of which is incorporated herein by reference, discloses a portable recycle crusher system having a hopper with inward and downward sloping sides, and fold-out hopper extensions. A belt feeder beneath the hopper slides on a slide deck made of a low friction, wear-resistant plastic bolted to a steel plate to prevent tearing of the belt when sharp pointed objects are dumped into the hopper. Stopping and starting and speed of the belt are controlled by remote radio control. Materials fall off the end of the belt feeder onto vibrating screen, which allows fine materials to bypass a crusher. The materials then enter a large rectangular opening of the crusher, and approach rotating hammers at a proper angle and speed. The hammers strike and break the materials and throw them against abrasion-resistant plates. The broken materials fall between the spinning hammers and through sizing screen steel grates, which provide positive product size control. The materials fall onto a discharge conveyor, which carries the materials away from the recycle crusher and to a delivery conveyor. The hopper, conveyors, crusher and scalper are mounted on a rectangular beam frame, which is supplied with an axle and wheels and a connector for towing the crusher system on roads. An engine mounted on the frame drives a hydraulic pump to operate the feeder and conveyor, and mechanically drives the crusher. The entire apparatus is mounted on an over-the-road trailer for towing to a road resurfacing location.

U.S. Pat. No. 5,927,359 (Donald Kersten), the disclosure of which is incorporated herein by reference, discloses a system and method which is designed to recover and recycle waste lumber wood scrap products from construction sites and process this waste scrap lumber into lengths of recycled, usable lumber. The system processes “2.times.4” and to “2.times.6” lumber scraps from one or more construction sites and processes such material into recycled construction material in the form of finger jointed “2.times.4” and “2.times.6” lumber. The method and system accepts and utilizes random lengths of different species with different moisture contents. After the construction waste wood scrap products are delivered to a recovery site, unusable wood scrap products are removed. The usable products are processed by squaring the ends and cutting out defects; and the “2.times.4” sizes are separated from the “2.times.6” sizes. Under-width product is removed; and the squared random lengths of remaining product then are continuously supplied to finger joint machines for fabricating desired lengths of finished recycled lumber, which then may be utilized in further construction.

U.S. Pat. No. 6,206,175 (Richard W. Tschantz), the disclosure of which is incorporated herein by reference, discloses a conveyor cleaning and residue control system for use with a conveyor includes an air knife and a deflector. The air knife impinges an air stream against the conveyor to blast residue from the conveyor, and the deflector redirects the air stream and the residue loosened by the air stream toward a chute. The flow of the air stream toward the chute causes at least a portion of the air-borne residue in the vicinity of the conveyor to flow toward the chute with the air stream such that the residue becomes supersaturated and forms macro-particles that precipitate out of air suspension. The air knife and deflector thus recycle the residue carried by the conveyor instead of requiring it to be evacuated. In the first embodiment, the deflector includes a pair of non-coplanar blades that are attached to one another. The deflector is both rotationally and translationally adjustable with respect to the conveyor. A second embodiment is disclosed wherein the deflector is curved. A third embodiment is disclosed wherein the deflector includes a servo mechanism that adjusts the orientation of the reflector with respect to the conveyor. A fourth embodiment is presented wherein the air knife and deflector are employed in a new construction material transport system that includes a shroud connected to the chute and an evacuation system connected to the downstream end of the shroud.

Thus, a need exists for a recycling apparatus and a process thereof.

This invention overcomes the problems of the prior art and provides a novel recycling apparatus and a process thereof.

### PURPOSES AND SUMMARY OF THE INVENTION

The invention is a novel recycling apparatus and a process thereof.

Therefore, one purpose of this invention is to provide a novel recycling apparatus and a process thereof.

Another purpose of this invention is to provide a recycling apparatus and a process thereof where at least a portion of the waste material is shredded.

Yet another purpose of this invention is to provide a recycling apparatus and a process thereof where the shredded waste material is sorted and valuable waste material is removed from the shredded waste material.

Therefore, in one aspect this invention comprises a process for sorting waste material, comprising the steps of:
(a) receiving a first waste load at a first location;
(b) removing at least a portion of said first waste load from said first location to a second location and forming a second waste load; and
(c) separating said second waste load at said second location into a valuable load and a worthless load, and thereby sorting said waste material.

Another aspect this invention comprises an apparatus for processing and sorting waste material, comprising:
(a) at least one first means for bringing a first waste load at a first location;
(b) at least one second means for removing at least a portion of said first waste load from said first location to a second location and forming a second waste load; and
(c) at least one third means for separating said second waste load at said second location into a valuable load and a worthless load, and thereby processing and sorting said waste material.

### BRIEF DESCRIPTION OF THE DRAWINGS

The features of the invention that are novel and the elements characteristic of the invention are set forth with particularity in the appended claims. The drawings are for illustration purposes only and are not drawn to scale. Furthermore, like numbers represent like features in the drawings. The invention itself, both as to organization and method of operation, may best be understood by reference to the detailed description which follows taken in conjunction with the accompanying drawings in which:

FIG. 1 is an exemplary layout of landfill area utilizing the novel apparatus and waste sorting process illustrating an embodiment of the present invention.

FIG. 2 is an exemplary layout of landfill area utilizing the novel apparatus and waste sorting process illustrating an embodiment of the present invention after several loads of waste material has been dumped at the dump site.

### DETAILED DESCRIPTION

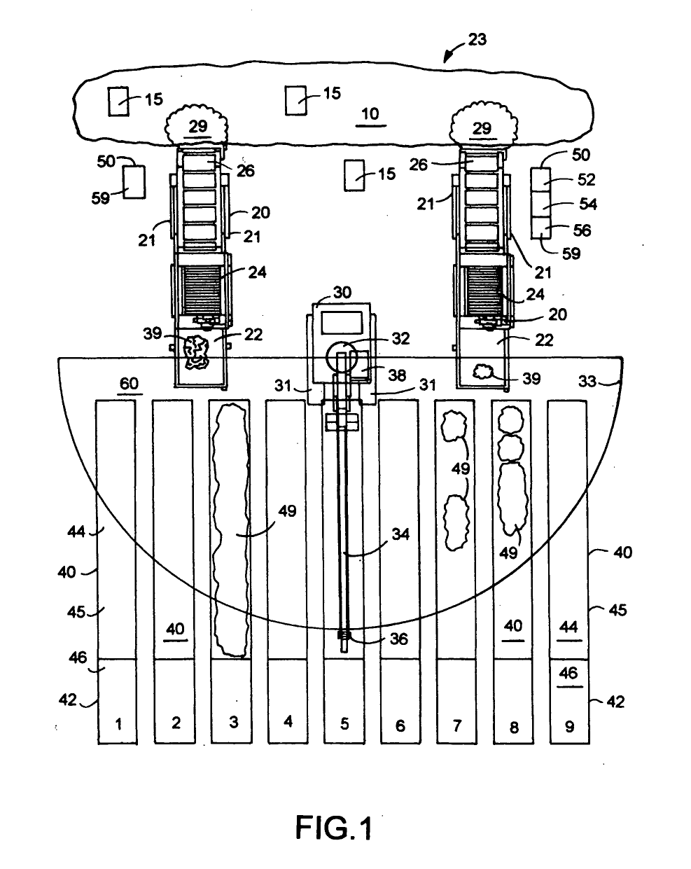

Referring now to FIG. 1, which is an exemplary layout of landfill area utilizing the novel apparatus and waste sorting process illustrating an embodiment of the present invention. The inventive landfill sorting apparatus 23, comprises at least one waste processing machine 20, at least one material handler 30, at a waste material dump site 60.

The waste processing machine 20, preferably is a portable waste processing machine 20, such as, for example, a crusher 20, or an annihilator 20, having at least one waste loading area or bin 22, at least one shredding or crushing area 24, and at least one conveyor belt 26. Adjacent to the waste processing machine 20, is at least one waste reclaim pile or bin or container 50. The waste reclaim container 50, can have a plurality of sub-piles or sub-bins or sub-containers 52, 54, and 56. The solid waste processing machine 20, could be on a plurality of tracks 21, and this would allow the mobility of the waste processing machine 20, from location to location or from one place to another place within the same general location or at a different location.

The material handler 30, preferably on a plurality of tracks 31, has a boom 34, that extends from a boom base or turret 32. The boom 34, has means to move a claw 36, or a bucket 36. The material handler 30, has at least one cabin 38, for the operator (not shown). The operator inside the cabin 38, can safely move the boom 34, along the boom radius 33, such as, from a left side to a right side or from one side to another side. The operator can also move the claw 36, or bucket 36, from a first position to a second position, where the first position or the second position are anywhere along the boom 34, or the boom radius 33. For some applications the claw 36, or the bucket 36, could have a built-in magnet mag grab (not shown). The built-in magnet mag grab can be used one of two ways. One way would be to securely hold-on to the ferrous material that the built-in magnet mag grab has attracted and/or work in conjunction with the claw 36, or the bucket 36, to further securely hold-on to the ferrous material that is in the grip of the claw 36, or the bucket 36.

The landfill sorting apparatus 23, is preferably located between a landfill 10, and an unloading lane or area 40. The landfill 10, has at least one landfill vehicle 15, such as, a bulldozer 15, a spreader 15, to name a few.

The unloading lane 40, preferably has a walking floor 42, where a waste hauler 45, can bring and unload its load 49. The waste hauler 45, could be a garbage truck 45, a dump truck 45, a tractor with trailer 45, or a similar waste hauling vehicle 45, to name a few. The load 49, could be household garbage 49, construction debris 49, demolition debris 49, industrial bulk material 49, to name a few.

As shown in FIG. 1, there are 9 waste haulers 45. The waste hauler number 3, has a full load of waste material 49, while waste hauler numbers 7 and 8, have a partial load of waste material 49. The waste hauler 45, typically comprises of a cab 44, and a trailer 46.

In a preferred operation the operator in the cabin 38, moves the claw or bucket 36, over the load 49. Either the boom 34, or the bucket 36, is lowered so as to collect or grab a load portion 39, of the load 49. The boom 34, along with the claw 36, having the collected load portion 39, of the load 49, is then moved above the waste loading area or bin 22, and the collected load portion 39, of the load 49, is then dropped into the waste loading area or bin 22, by either lowering the boom 34, or the bucket 36. For some applications the load portion 39, is then processed through at least one shredding area 24, where at least a portion of the load portion 39, is preferably shredded into smaller portions 39. The load portion 39, or the shredded load portion 39, is then put on at least one conveyor 26, where it is sorted. The shredded load portion 39, that is processed over the conveyor 26, basically is divided into at least one first group and at least one second group, where the first group is a sorted or processed waste material or worthless waste 29, that can be dumped onto the landfill 10, and a second group which is a reclaimed waste or valuable waste 59, which can be collected and placed into the waste reclaim bin or pile 50.

The sorted or processed waste material or the worthless waste 29, can be moved over into the landfill 10, using the landfill vehicles 15.

The reclaimed waste or valuable waste 59, can be removed from the landfill site 10, using a waste hauler 45 or a similar waste hauling vehicle 45.

For safety and security purposes it is recommended that no personnel or individual be allowed outside the equipment 20 or 30, during operations, except for any required maintenance.

It is preferred that the waste processing machine 20, be a CBI Low Speed Mobile Annihilator 20, or any other equivalent unit 20, which is either on tracks or is in a temporarily fixed position.

It is also preferred that the material handler 30, be a Sennebogen Elevated Cab Mag-Grab 835R-HD material handler 30, or any other equivalent unit 30.

The preferred dimension for the walking floor 42, is between about 7 feet to about 10 feet wide, and preferably about 8 feet wide, and between about 30 feet to about 53 feet long, and preferably, about 8 feet wide, and about 50 feet long.

For most applications the boom 34, that has a boom length of between about 40 feet to about 80 feet, is recommended, and preferably the boom 34, is about 50 feet long so as to create a boom radius 33, of about 50 feet. The boom 34, could also have a telescopic boom component so as to extend the length of the boom 34.

In some applications the waste processing machine 20, could be provided with at least one vibration table (not shown) so as to loosen-up the load portion 39. The loosened up material 39, could then be carried via a feeding belt onto a roller screen (not shown), where the screening of fine parts or undersized grain and oversized grain could take place. The fine parts or undersized grain in the recycling industry are typically parts that are, for example, between about 0.1 cubic inches to about 5.0 cubic inches, and parts that are typically larger than, for example, 5.0 cubic inches, are referred to as oversized grain. The rest of the loosened up material 39, minus the fine parts, but containing the oversized grain, could then be sent onto the sorting belt or conveyor 26, for further sorting. The fine parts and the unsorted material is typically discharged via a sorting belt as sorted or processed waste material 29. It is preferred that the grain size that is sorted for the reclaimed waste 50, is between about 5 cubic inches to about 20 cubic inches, and more preferably between about 6 cubic inches to about 16 cubic inches.

The waste processing machine 20, could also be provided with at least one magnet station (not shown), where the ferrous material or parts are separated, such as, by at least one electromagnet or a permanent magnet or at least one electric-over-belt magnet or at least one electro-cross-belt magnet and then the collected metallic or ferrous material or parts could be discharged towards or onto the waste reclaim pile or bin 50.

The waste processing machine 20, could also be provided with at least one eddy current separator (not shown) so that the nearly metal or ferrous free material could also be processed through the eddy current separator, where the non-ferrous parts can be separated and discharged via the discharge belt 26, as sorted or processed waste material 29, and the collected ferrous material or parts could be discharged towards or onto the waste reclaim pile or bin 50.

The waste processing machine 20, could also be provided with at least one metal detector (not shown), where the metal detector detects and sorts or separates all metal parts from non-ferrous parts. The non-ferrous parts can then be separated and discharged via the discharge belt 26, as sorted or processed waste material 29, and the collected ferrous material or parts could be discharged towards or onto the waste reclaim pile or bin 50.

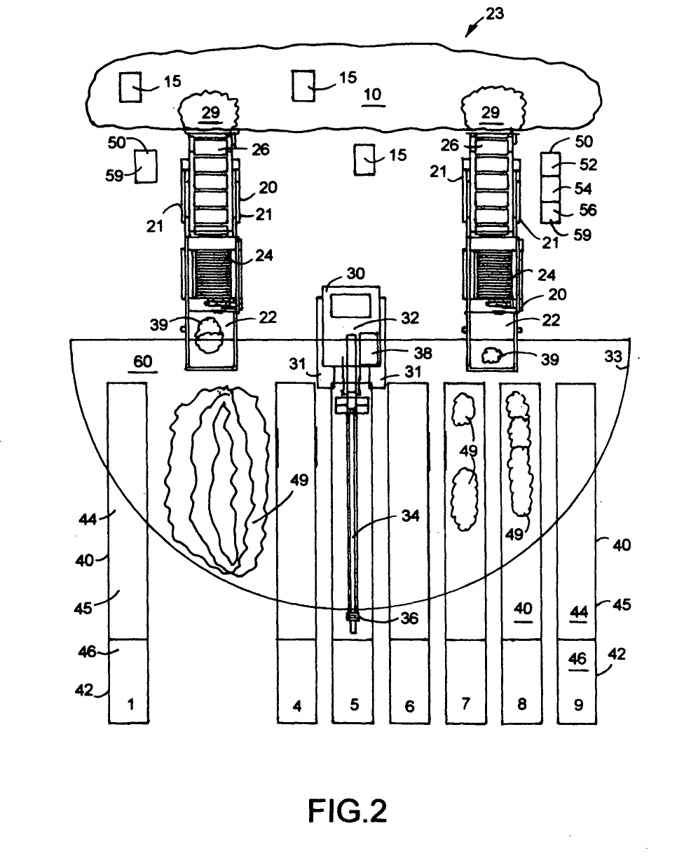

FIG. 2 is an exemplary layout of landfill area 10, utilizing the novel apparatus 23, and waste sorting process illustrating an embodiment of the present invention after several loads of waste material 49, have been dumped at the dump site 60. As one can see that the waste hauler number 2 and 3, have dumped their waste material load 49, and have left the dump site 60. Typically, the waste haulers 45, reverse their vehicles 45, at the dump site 60, and then dump their loads 49, from the trailers 44, as they start moving forward so that a small pile or hill of waste material load 49, is left behind. The trailers 44, could be covered trailers 44, as seen in trailers 1, 4, 5, 6 and 9, or open trailers 44, as seen in trailers 7 and 8.

The load 49, has material selected from a group comprising domestic waste, industrial waste, commercial waste, construction debris, demolition debris, recyclable glass, recyclable metals, refrigerator, air conditioner, hot water heater, dish washer, stove, small kitchen appliances, mattress, box springs, yard material, bulky waste, car bodies, scrap bulk metal, waste wood, cable drums, railroad ties, telephone poles, lumber, tree trunks, and combination thereof, to name a few.

The reclaimed waste 50, has material selected from a group comprising metal, brass, copper, aluminum, ferrous material, bulky metallic material, metallic parts from car bodies, scrap bulk metal, to name a few.

The preferred embodiment of this invention has been described with reference to a landfill location 10, however, it should be understood that the landfill sorting apparatus 23, can be erected at any location where incoming waste 49, can be sorted into valuable waste 50, and worthless waste 29. And, where the valuable waste 50, can be removed and further recycled, and the worthless waste 29, can be moved to a landfill 10, or a similar such location 10, such as, a land reclaim site 10.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A process for sorting waste material, comprising the steps of:
(a) receiving a first waste load at a first location;
(b) removing at least a portion of said first waste load from said first location to a second location and forming a second waste load; and
(c) separating said second waste load at said second location into a valuable load and a worthless load, and thereby sorting said waste material.

2. The process for sorting waste material of claim 1, wherein said waste material is selected from a group consisting of domestic waste, industrial waste, commercial waste, construction debris, demolition debris, recyclable glass, recyclable metals, refrigerator, air conditioner, hot water heater, dish washer, stove, small kitchen appliances, mattress, box springs, yard material, bulky waste, car bodies, scrap bulk metal, waste wood, cable drums, railroad ties, telephone poles, lumber, tree trunks, and combination thereof.

3. The process for sorting waste material of claim 1, wherein said first waste load is delivered to said first location by a means selected from a group consisting of a waste hauler, a garbage truck, a dump truck, a tractor with trailer, and a waste hauling vehicle.

4. The process for sorting waste material of claim 1, wherein said step of removing said at least a portion of said first waste load from said first location to a second location is done using at least one material handler.

5. The process for sorting waste material of claim 1, wherein said step of removing said at least a portion of said first waste load from said first location to a second location is done using at least one material handler, and wherein said material handler has at least one means to move said material handler from a first material handling location to a second material handling location.

6. The process for sorting waste material of claim 1, wherein said step of removing said at least a portion of said first waste load from said first location to a second location is done using at least one material handler, and wherein said material handler has at least one boom having at least one means to pick said at least a portion of said first waste load.

7. The process for sorting waste material of claim 1, wherein said step of removing said at least a portion of said first waste load from said first location to a second location is done using at least one material handler, and wherein said material handler has at least one boom having at least one means to pick said at least a portion of said first waste load, and wherein said means to pick is selected from a group consisting of a claw and a bucket.

8. The process for sorting waste material of claim 1, wherein said second location of step (b) is at least one waste processing machine.

9. The process for sorting waste material of claim 1, wherein said second location of step (b) is at least one waste processing machine, and wherein said waste processing machine has at least one means to move said waste processing machine from a first processing location to a second processing location.

10. The process for sorting waste material of claim 1, wherein said valuable load is selected from a group consisting of metal, brass, copper, aluminum, ferrous material, bulky metallic material, metallic parts from car bodies, scrap bulk metal, and combinations thereof.

11. An apparatus for processing and sorting waste material, comprising:
(a) at least one first means for bringing a first waste load at a first location;
(b) at least one second means for removing at least a portion of said first waste load from said first location to a second location and forming a second waste load; and
(c) at least one third means for separating said second waste load at said second location into a valuable load and a worthless load, and thereby processing and sorting said waste material.

12. The apparatus for processing and sorting waste material of claim 11, wherein said waste material is selected from a group consisting of domestic waste, industrial waste, commercial waste, construction debris, demolition debris, recyclable glass, recyclable metals, refrigerator, air conditioner, hot water heater, dish washer, stove, small kitchen appliances, mattress, box springs, yard material, bulky waste, car bodies, scrap bulk metal, waste wood, cable drums, railroad ties, telephone poles, lumber, tree trunks, and combination thereof.

13. The apparatus for processing and sorting waste material of claim 11, wherein said first means is selected from a group consisting of a waste hauler, a garbage truck, a dump truck, a tractor with trailer, and a waste hauling vehicle.

14. The apparatus for processing and sorting waste material of claim 11, wherein said second means is at least one material handler.

15. The apparatus for processing and sorting waste material of claim 11, wherein said second means is at least one material handler, and wherein said material handler has at least one means to move said material handler from a first material handling location to a second material handling location.

16. The apparatus for processing and sorting waste material of claim 11, wherein said second means is at least one material handler, and wherein said material handler has at least one boom having at least one means to pick said at least a portion of said first waste load.

17. The apparatus for processing and sorting waste material of claim 11, wherein said second means is at least one material handler, and wherein said material handler has at least one boom having at least one means to pick said at least a portion of said first waste load, and wherein said means to pick is selected from a group consisting of a claw and a bucket.

18. The apparatus for processing and sorting waste material of claim 11, wherein said third means is at least one waste processing machine.

19. The apparatus for processing and sorting waste material of claim 11, wherein said third means is at least one waste processing machine, and wherein said waste processing machine has at least one means to move said waste processing machine from a first processing location to a second processing location.

20. The apparatus for processing and sorting waste material of claim 11, wherein said valuable load is selected from a group consisting of metal, brass, copper, aluminum, ferrous material, bulky metallic material, metallic parts from car bodies, scrap bulk metal, and combinations thereof.
